(19) United States
(12) Patent Application Publication
(10) Pub. No.: US 2016/0180376 A1
(43) Pub. Date: Jun. 23, 2016

(54) SYSTEMS AND METHODS FOR AD CAMPAIGN OPTIMIZATION

(71) Applicant: Yahoo! Inc., Sunnyvale, CA (US)

(72) Inventors: Zhonghao LU, Beijing (CN); Jian Xu, San Jose, CA (US); Lixing Bo, Beijing (CN)

(73) Assignee: Yahoo! Inc., Sunnyvale, CA (US)

(21) Appl. No.: 14/585,961

(22) Filed: Dec. 30, 2014

Related U.S. Application Data
(63) Continuation of application No. PCT/CN2014/094474, filed on Dec. 22, 2014.

(51) Int. Cl. G06Q 30/02

(52) U.S. Cl. CPC G06Q 30/0244

(57) ABSTRACT

A computer system that implements a method for optimizing an ad campaign may be configured to receive an online ad display request to display an ad to a viewer and obtain at least three probabilities—a first probability that the ad will receive a positive response from the viewer, a second probability that the ad will receive a neutral response from the viewer, and a third probability that the ad will receive a negative response from the viewer. Additionally, the computer system may also be configured to determine a gain value of displaying the ad; and determine a bidding price associated with the ad request based on the gain value.

### PRIORITY STATEMENT

This application is a continuation of International Application No. PCT/CN 2014/094474, filed on Dec. 22, 2014, in the State Intellectual Property Office of the People's Republic of China, the disclosures of which is incorporated herein in its entirety by reference.

### BACKGROUND

Online advertising is a successful business with multi-billion dollars revenue growth over the past years. The goal of online advertising is to serve ads to the right person in the right context. The efficiency of online advertising typically can be measured by different types of viewer responses, such as clicks, conversions, etc. In order to achieve the best ad efficiency, advertising systems try to predict the occurrence of viewer responses accurately based on information of advertiser, publisher and viewer attributes. Such prediction is important to both publishers and advertisers. With an accurate prediction, a publisher can make better profit estimations to its services; and an advertiser can better design ad campaigns.

Nowadays some advertisers and/or publishers provide online ads that include close buttons thereon, so that when the ads are displayed to viewers, the viewers may be able to close the ads. When an ad is closed, the ad may not be display again to the viewer's web browser. A viewer's response to close an ad may serve as important feedback information for building or improving response prediction models, one of the central problems in online advertising.

### SUMMARY

The present disclosure relates to systems and methods for ad campaign optimization. In the systems and methods discussed below, a presentation server collects explicit negative feedback from Internet users towards ads. By collecting explicit negative feedbacks from viewers towards ads with an “ad feedback” feature, the systems and methods may construct response prediction models to predict probabilities that a viewer may close, not response to, or click and/or realize an ad sent to the viewer. The systems and methods may use negative feedback aware prediction models to leverage negative feedback data as both targets and features. The systems and methods may also implement negative feedback aware bidding policies to promote ad campaign strategies of advertisers and publishers, thereby improve the performance and effectiveness of advertising systems such as YAM+.

According to an aspect of the present disclosure, a computer system may comprise a processor-readable, non-transitory storage medium, comprising a set of instructions for optimizing an ad campaign, and a processor in communication with the storage medium. When the processor executes the set of instructions, the processor may be directed to receive an online ad display request to display an ad to a viewer and obtain three probabilities: a first probability that the ad will receive a positive response from the viewer, a second probability that the ad will receive a neutral response from the viewer, and a third probability that the ad will receive a negative response from the viewer. The processor may also be directed to determine a gain value of displaying the ad based on the first probability, the second probability, and the third probability; determine a bidding price for the ad associated with the ad request based on the gain value; and send the bidding price to a client in obtaining an ad display opportunity associated with the ad request.

According to another aspect of the present disclosure, a method for optimizing an ad campaign may comprising, by at least one computer, receiving an online ad display request to display an ad to a viewer and obtaining three probabilities—a first probability that the ad will receive a positive response from the viewer, a second probability that the ad will receive a neutral response from the viewer, and a third probability that the ad will receive a negative response from the viewer. The method may also comprise determining a gain value of displaying the ad based on the first probability, the second probability, and the third probability; determining a bidding price for the ad associated with the ad request based on the gain value; and sending the bidding price to a client in obtaining an ad display opportunity associated with the ad request.

According to yet another aspect of the present disclosure, a processor-readable, non-transitory storage medium, may comprise a set of instructions for optimizing an ad campaign. The set of instructions, when executed by a processor, may direct the processor to perform actions of receiving an online ad display request to display an ad to a viewer; and obtaining three probabilities - a first probability that the ad will receive a positive response from the viewer, a second probability that the ad will receive a neutral response from the viewer, and a third probability that the ad will receive a negative response from the viewer. Additionally, the set of instruction may also direct the processor to perform actions of determining a gain value of displaying the ad based on the first probability, the second probability, and the third probability; determining a bidding price for the ad associated with the ad request based on the gain value; and sending the bidding price to a client in obtaining an ad display opportunity associated with the ad request.

### BRIEF DESCRIPTION OF THE DRAWINGS

The described systems and methods may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a schematic diagram of one embodiment illustrating a network environment that the systems and methods in the present disclosure may be implemented;

FIG. 2 is a schematic diagram illustrating an example embodiment of a server;

FIG. 3 is a schematic diagram illustrating an example online advertising system;

FIG. 4 is an example webpage showing an ad being displayed thereon; and

FIG. 5 is a flowchart illustrating a procedure to determine a recommended bidding price.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

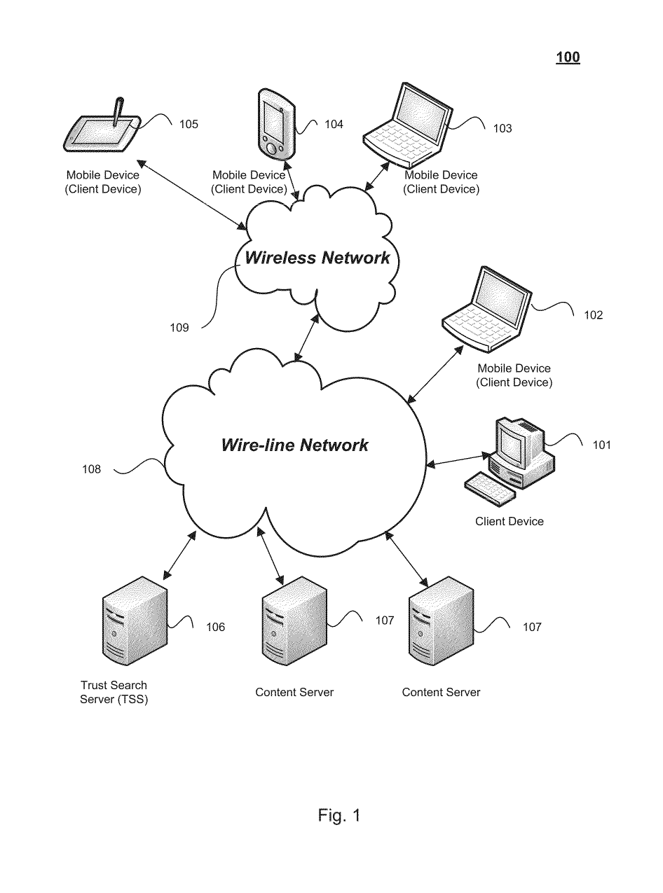

FIG. 1 is a schematic diagram of one embodiment illustrating a network environment in which the systems and methods in the present application may be implemented. Other embodiments of the network environments that may vary, for example, in terms of arrangement or in terms of type of components, are also intended to be included within claimed subject matter. As shown, FIG. 1, for example, a network 100 may include a variety of networks, such as Internet, one or more local area networks (LANs) and/or wide area networks (WANs), wire-line type connections 108, wireless type connections 109, or any combination thereof. The network 100 may couple devices so that communications may be exchanged, such as between servers (e.g., content server 107 and search server 106 ) and client devices (e.g., client device 101-105 and mobile device 102-105 ) or other types of devices, including between wireless devices coupled via a wireless network, for example. A network 100 may also include mass storage, such as network attached storage (NAS), a storage area network (SAN), or other forms of computer or machine readable media, for example.

A network may also include any form of implementation that connects individuals via communications network or via a variety of sub-networks to transmit/share information. For example, the network may include content distribution systems, such as peer-to-peer network, or social network. A peer-to-peer network may be a network employ computing power or bandwidth of network participants for coupling nodes via an ad hoc arrangement or configuration, wherein the nodes serves as both a client device and a server. A social network may be a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like. A social network also may generate relationships or connections with entities other than a person, such as companies, brands, or so- called ‘virtual persons.’ An individual's social network may be represented in a variety of forms, such as visually, electronically or functionally. For example, a “social graph” or “socio-gram” may represent an entity in a social network as a node and a relationship as an edge or a link. Overall, any type of network, traditional or modern, that may facilitate information transmitting or advertising is intended to be included in the concept of network in the present application.

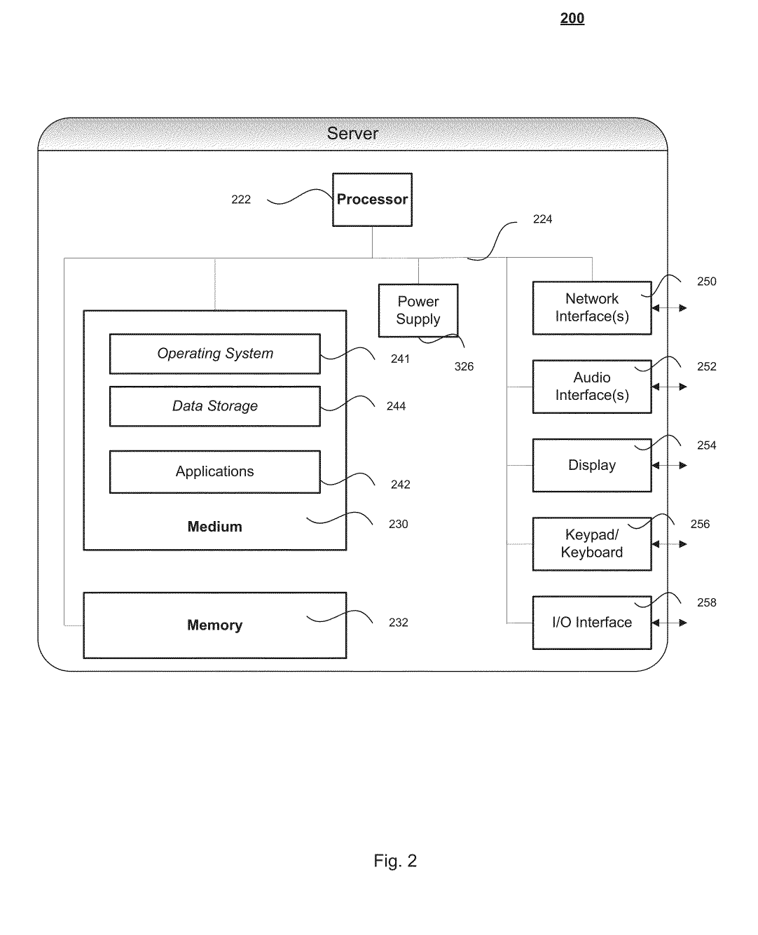

FIG. 2 is a schematic diagram illustrating an example embodiment of a server. A Server 200 may vary widely in configuration or capabilities, but it may include one or more central processing units (e.g., processor 222 ) and memory 232, one or more medium 230 (such as one or more non-transitory processor-readable mass storage devices) storing application programs 242 or data 244, one or more power supplies 226, one or more wired or wireless network interfaces 250, one or more input/output interfaces 258, and/or one or more operating systems 241, such as WINDOWS SERVER™, MAC OS X™, UNIX™, LINUX™, FREEBSD™, or the like. Thus a server 200 may include, as examples, dedicated rack-mounted servers, desktop computers, laptop computers, set top boxes, integrated devices combining various features, such as two or more features of the foregoing devices, or the like.

The server 200 may serve as a search server 106 or a content server 107. A content server 107 may include a device that includes a configuration to provide content via a network to another device. A content server may, for example, host a site, such as a social networking site, examples of which may include, but are not limited to, FLICKER™, TWITTER™, FACEBOOK™, LINKEDIN™, or a personal user site (such as a blog, vlog, online dating site, etc.). A content server 107 may also host a variety of other sites, including, but not limited to business sites, educational sites, dictionary sites, encyclopedia sites, wikis, financial sites, government sites, etc. A content server 107 may further provide a variety of services that include, but are not limited to, web services, third party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example. Examples of devices that may operate as a content server include desktop computers, multiprocessor systems, microprocessor type or programmable consumer electronics, etc.

Merely for illustration, only one processor will be described in sever or servers that execute operations and/or method steps in the following example embodiments. However, it should be note that the server or servers in the present disclosure may also include multiple processors, thus operations and/or method steps that are performed by one processor as described in the present disclosure may also be jointly or separately performed by the multiple processors. For example, if in the present disclosure a processor of a server executes both step A and step B, it should be understood that step A and step B may also be performed by two different processors jointly or separately in the server (e.g., the first processor executes step A and the second processor executes step B, or the first and second processors jointly execute steps A and B).

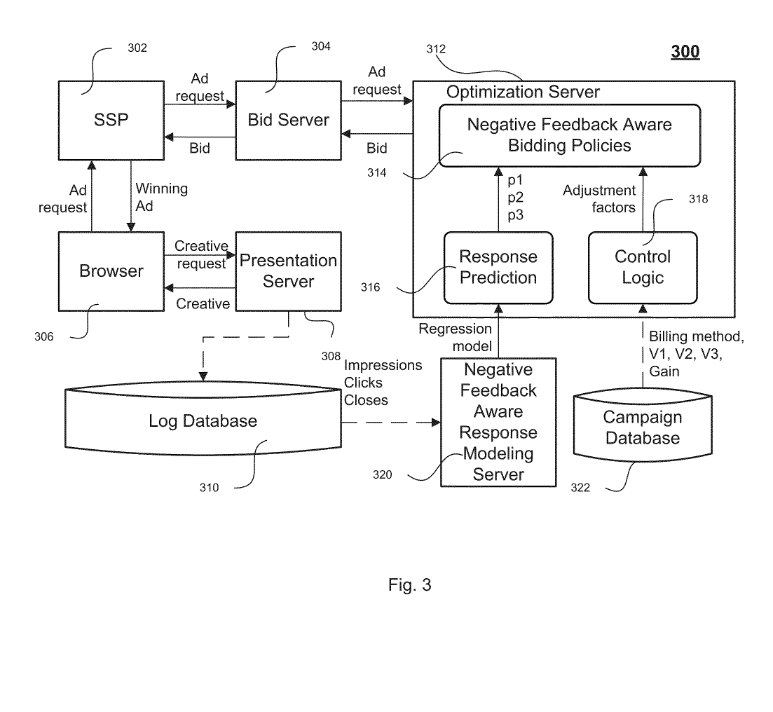

FIG. 3 illustrates an online advertising system 300 according to example embodiments of the present disclosure. The system 300 may include at least one supply-side platform, or sell-side platform, (SSP) 302, at least one bid server 304, at least one presentation server 308, at least one log database 310, at least one optimization server 312, at least one campaign database 322, and at least one modeling server 320. The servers in the system 300 may be of a structure of the server 200. The databases in the system may include a non-transitory storage medium accessible by the servers, either locally or remotely through a network.

When a viewer visits a website associated with the SSP 302 via a browser 306, the viewer generates an online advertising opportunity. The browser 306 may send an ad request (i.e., ad display opportunity) to the SSP 302. The SSP 302 is a technology platform enabling publishers to manage their advertising impression inventory and maximize revenue from digital media. The SSP 302 may provide one or more publishers interfaces to an ad exchange, which in turn may interface to a demand-side platform (DSP) on advertiser side.

The SSP 302 may broadcast the ad request to a plurality of advertisers through a DSP and hold an auction for the ad display opportunity. The auction may take any form available in the field of online advertising. For example, the auction may be a second-price auction or a preserve-price auction. The plurality of advertisers may bid on the opportunity with their respective ads through the bid server 304.

A winning ad may subsequently be determined in the auction. The SSP 302 may send the winning ad information to the browser 306, which may send a creative request to a presentation server 308. In response to the creative request, the presentation server 308 may retrieve an ad creative corresponds to the winning ad, and send the creative to the browser 306.

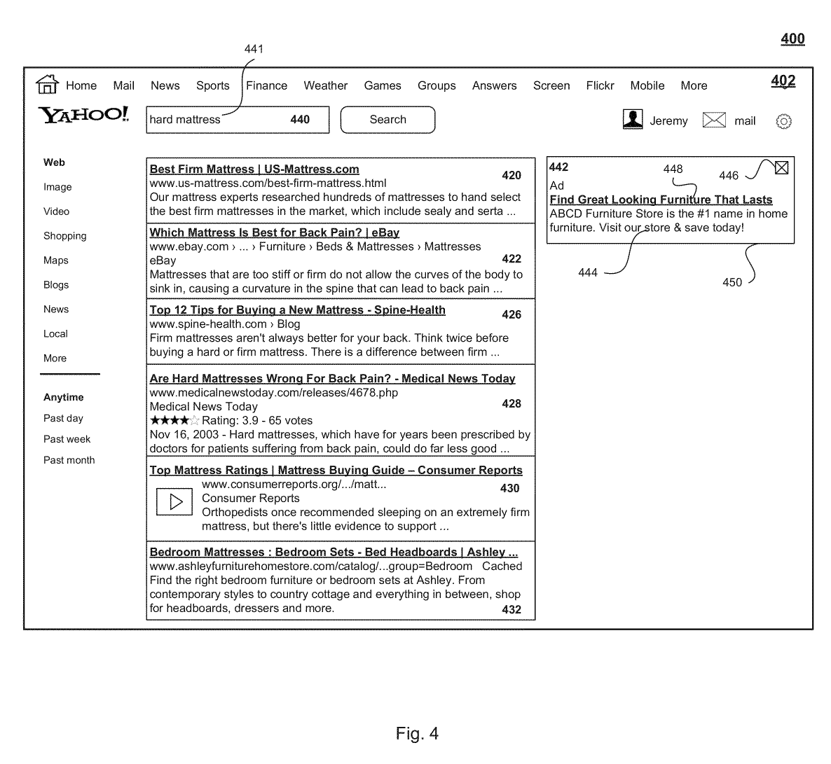

FIG. 4 is an example showing an ad being displayed on a webpage of the browser 306. The webpage 402 may include a search input box 440. The viewer may input a search query 441 in the search input box 440. A content server (not shown) may return and show search results 420, 422, 426, 428, 430, and 432 on the webpage 402. For example, in the webpage 402 shown in FIG. 4, a user inputs a search query “hard mattress.” The webpage 402 may include a section 450 to display the winning ad 442, including the creative 444 sent from the presentation server 308. The winning ad 442 may be displayed to bring to the attention of the viewer and promote a product and/or service of an advertiser. For example, the section 450 may be part of the webpage adjacent to main content of the webpage 400, or may be a section appearing over a video chip when the viewer is watching the video. The winning ad 442 may be selected based on the search query 441 in the search input box 440, and/or based on contents of the webpage 402. The ad 442 may include the creative 444 sent from the presentation server 308.

The ad 442 may also include a feedback port 446, 448, which allows the viewer to send a feedback about the ad. For example, the feedback port may include a close button 446 and a hyperlink 448. The close button 446 may be configured to close the ad; and the hyperlink 448 may be configured to direct the viewer to a target webpage, such as a landing page of the advertiser. By clicking the hyperlink, the viewer may indicate his/her interest in the winning ad 442, thereby expressing a positive response towards the winning ad 442; and by clicking the close button, the viewer may indicates that he/she dislike the winning ad 442, either because the winning ad 442 is offensive, annoying, discomforting, or other reasons. Thus an action of closing the ad may be a negative response towards the winning ad 442. If the viewer conducts no operation on the feedback port 446, 448, the do-nothing may reflect a neutral response towards the winning ad 442, i.e., it may indicate an ad impression has been successfully delivered to the viewer, but whether the viewer likes the winning ad or not remains unknown.

Alternatively, the feedback port may be of other form so that an action operated on the feedback port may reflect a predetermined attitude of the viewer towards the winning ad 442.

The browser 306 may send data (ad display data) of the displayed winning ad 422 to the presentation server 308. Then the presentation server 308 may send the ad display data, including the viewer's feedback information, to a log database 310.

In addition to the viewer's feedback information, the ad display data may also include factors (hereinafter “realization factors”) that have impacts on realization probability of the winning ad. The realization probability may include probabilities of various responses that the viewer may have to the display of an ad, such as the positive response, neutral response, and negative response. For example, in an ad display instance, realization factors related to the viewer may include the viewer's demographic information such as age, gender, race, geographic location, language, education, income, job, and hobbies. Factors related to the publisher that displays the ad may include information regarding a webpage that displays the ad (e.g., webpage URL, webpage ID, and/or content category of the webpage, etc.), the domain information (e.g., URL, ID, and/or category of the website containing the webpage), and information and/or category of the publisher that places the ad on the webpage. Realization factors related to the advertiser may include information of the ad (e.g., ID, content/creative, and/or category of the ad), information of the ad campaign (e.g., ID and/or category of the ad campaign) that the ad belongs to, and/or the information of the advertiser (e.g., ID and/or category of the advertiser) that runs the ad campaign. These factors may all contribute to the response that the user may have to the ad. With a possible response, such as click the ad, the viewer may conduct a realization to the ad, whereas a negative response, such as close the ad, the viewer may show his/her dislike attitude to the ad.

Note that the realization factors in the ad display data may have natural hierarchy relationships. For example, the viewer's hobby may include sports in a Sport category and arts in an Art category. Additionally, the Sport category may be further divided into different sub-categories such as golf and fishing. Similarly, on the publisher side, a publisher may run a number of domains (e.g., websites), and each domain may include a plurality of webpages. On the advertiser side, ad Campaign Group1 may include ad Campaign1, which may further include a plurality of ads such as Ad1 and Ad2.

Thus, by collecting the ad display data of various ad display instances, the log database 310 may include ad display data of a plurality of historical ad display instances. The log database 310 of the historical ad display instances may be used to analyze probabilities of how a viewer may response when the viewer watches an ad displayed on his/her browser.

To this end, the modeling server 320 may construct a negative feedback aware response model to predict viewer's response to an ad. For example, the negative feedback aware model may predict not only a probability that the viewer will realize the ad (e.g., click the ad), but also probabilities that the viewer will close the ad and do nothing to the ad.

The modeling server 320 may adopt any feasible algorithm for the model construction. For example, for the trichotomy of categorizing the viewer's responses as positive response (e.g., click), neutral response (e.g., do-nothing), and negative response (e.g., close), the modeling server may adopt a multinomial logistic regression algorithm to construct the negative feedback aware model. Here, multinomial logistic regression is an algorithm that may be used to predict probabilities of more than two classes. It is a model that may be used to predict the probabilities of the different possible outcomes of a categorically distributed dependent variable, given a set of independent variables (known as “features”). In ad response prediction context, the features may be the realization factors.

Letting p1=p(positive|ad request, ad) be the probability of positive response, p2=p(neutral|ad request, ad) be the probability of neutral response, and p3=p(negative|ad request, ad) be the probability of negative response, under the multinomial logistic regression model the three probabilities may be formulated as:

$$p 1 = \frac{{e}^{{β}_{positive} \cdot X}}{( {e}^{{β}_{positive} \cdot X} + {e}^{{β}_{neutral} \cdot X} + {e}^{{β}_{negative} \cdot X} )} ;$$

$$p 2 = \frac{{e}^{{β}_{neutral} \cdot X}}{( {e}^{{β}_{positive} \cdot X} + {e}^{{β}_{neutral} \cdot X} + {e}^{{β}_{negative} \cdot X} )} ;$$

$$and$$

$$p 3 = \frac{{e}^{{β}_{negative} \cdot X}}{( {e}^{{β}_{positive} \cdot X} + {e}^{{β}_{neutral} \cdot X} + {e}^{{β}_{negative} \cdot X} )} ,$$

where p1+p2+p3=1. X={x₁, x₂, . . . , xₖ} is a feature vector where each feature xᵢ, i=1, . . . , k is a realization factor descried by the (ad request, ad) pair. For example, the feature xᵢ may have a value of 0 or 1 indicating whether the viewer from the ad request has ever closed any ads of the advertiser before. βₚₒₛᵢₜᵢᵥₑ, βₙₑᵤₜᵣₐₗ, and β_{negative} are coefficient vectors to be learned from the historical ad display data.

There may have various algorithms to be used to determine the coefficient vectors βₚₒₛᵢₜᵢᵥₑ, βₙₑᵤₜᵣₐₗ, and β_{negative}. The present disclosure intends to cover any suitable algorithms that may be adopted by one of ordinary skill in the art. As an example, the coefficient vectors βₚₒₛᵢₜᵢᵥₑ, βₙₑᵤₜᵣₐₗ, and β_{negative} may be determined by first minimizing a cost function. The cost function may be formulated as:

$$J ( {β}_{positive} , {β}_{neutral} , {β}_{negative} ) = [ \frac{1}{m} {\sum }_{i = 1}^{m} {\sum }_{j = positive , neutral , negative} 1 \{ {y}^{( i )} = j \} \cdot log \frac{{e}^{{β}_{j} \cdot {X}^{( i )}}}{( {e}^{{β}_{positive} \cdot X} + {e}^{{β}_{neutral} \cdot X} + {e}^{{β}_{negative} \cdot X} )} ] ,$$

where m is the number of labeled examples in the training data of historical ad display instances, (X⁽ⁱ⁾, y⁽ⁱ⁾, i=1, m are the training data of historical ad display instances, and 1{·} is an indicator function, so that 1{a true statement}=1, and 1{a false statement}=0. For example, 1{1+2 =3} evaluates to 1; whereas 1{1+2=4} evaluates to 0.

After minimizing the cost function, the modeling server 320 may jointly determine the coefficient vectors βₚₒₛᵢₜᵢᵥₑ, βₙₑᵤₜᵣₐₗ, and β_{negative} by a gradient descent algorithm under the maximum a posteriori (MAP) decision rule. Once the modeling server 320 determines the coefficient vectors βₚₒₛᵢₜᵢᵥₑ, βₙₑᵤₜᵣₐₗ, β_{negative}, the modeling server 320 may determine the probabilities of positive, neutral, and negative responses.

Knowing the probabilities of viewers' response is important to both the publisher and the advertiser. For an advertiser, the probabilities may help determine bidding prices of ad requests and budgets for ad campaign. For a publisher, the probabilities may help evaluate commercial gains of designing service packages of ad campaigns.

In FIG. 3, when the browser 306 sends the ad request to the bid server 304, the bid server 304 may send the ad request to the optimization server 312 to determine a bidding price. To this end, the optimization server 312 may first obtain the negative feedback aware response model from the model server 320. Then the optimization server 312 may apply the negative feedback aware response model to the ad request to determine the probability p1 of receiving a positive response, the probability p2 of receiving a neutral response, and the probability p3 of receiving a negative response of an ad when a browser displays the ad in response to the ad request. Using the three probabilities, the optimization server 312 may determine a value of a gain of displaying the ad through negative feedback aware bidding polices 314, and then determine the bidding price based on the gain. Subsequently, the optimization server 312 may send the bidding price to the bid server 304 as a recommendation, which may bid on the ad request accordingly.

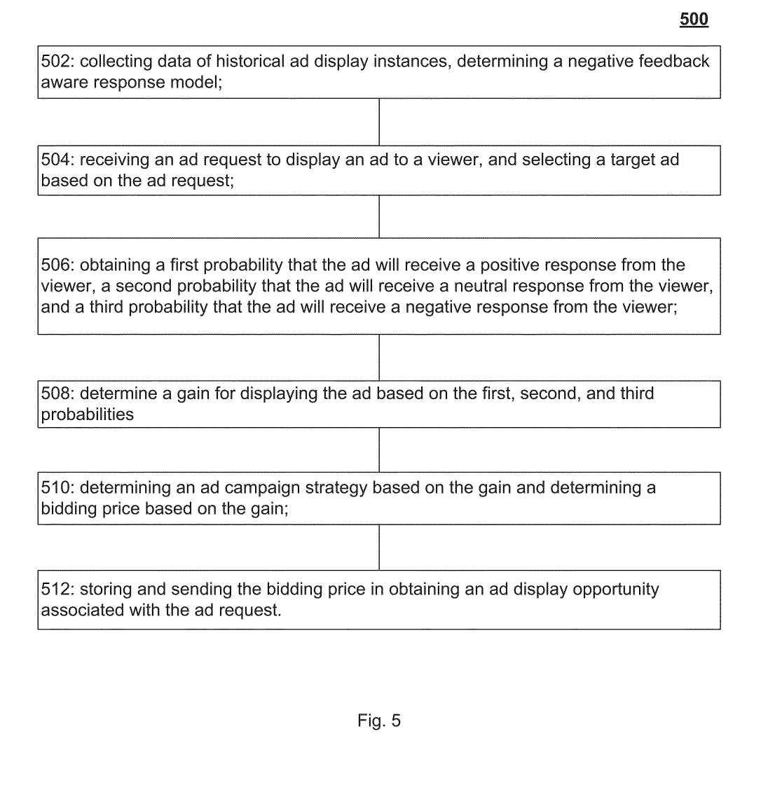

FIG. 5 is a flowchart illustrating a procedure to determine a recommended bidding price. The procedure may be implemented as a set of instructions stored in a non-transitory storage medium accessible by the optimization server 312 and the modeling server 320, and executed by processors of the modeling server 320 and the optimization server 312. The procedure may include the following operations.

At Operation 502 the modeling server 320 may collect the data of historical ad display instances from the log database 310, and modeling these historical ad display instances with a negative feedback aware response model.

For example, the modeling server 320 may select a set of historical ad display instances from the log server 310 as training data, and retrieve the features to construct the feature vector X={x₁, x₂, . . . ,xₖ} based on the set of historical ad display instances. The modeling server 320 may minimize the cost function and jointly determine the coefficient vectors βₚₒₛᵢₜᵢᵥₑ, βₙₑᵤₜᵣₐₗ, β_{negative} by the gradient descent algorithm under the maximum of a posteriori (MAP) decision rule. Next, the modeling server 310 may train with the selected set of historical ad display instances and respectively calculate and/or determine distributions of the probability of positive response p1, the probability of neutral response p2, and the probability of negative response p3 in the selected set of historical ad display instances.

At Operation 504 the optimization server 312 may receive the ad request from the browser 306 to display an ad to a viewer. One of the optimization sever 312, the bid server 304, and the presentation server 308 may select a target ad in response to the ad request.

The ad request may include realization factors about the publisher, the advertiser that plan to bid the ad request, and the viewer. The realization factors may include target ad information. The target ad may be an ad from the ad campaign database 322 that matches best to the ad request. It may be selected by the bid server 304. Alternatively, the optimization server 312 or the presentation server 308 may select the target ad according to the ad request. As set forth above, the realization factors are factors that have an impact on a realization associated with winning an ad. Example realization factors may include, but not limited to, the viewer's demographical information, the publisher's information such as information of the website and webpage on which the ad is displayed, and the advertiser's information such as the ad creatives and information of the corresponding ad campaign.

At Operation 506, based on the ad information, the optimization server 312 may obtain the three probabilities, i.e., the first probability p1 that the target ad will receive a positive response, the second probability p2 that the target ad will receive a neutral response, and the third probability p3 that the target ad will receive a negative response when the browser displays an ad in response to the ad request.

To this end, the optimization server 312 may analyze the ad request and the target ad, determine the corresponding realization factors as features xᵢ in the (ad request, ad) pair, and construct the feature vector X={xᵢ}. Then the optimization server 312 may take the feature vector X={xᵢ} and the coefficient vectors βₚₒₛᵢₜᵢᵥₑ, ⊕ₙₑᵤₜᵣₐₗ, and β_{negative} to determine the first, second, and the third probabilities, using the formula:

$$p 1 = \frac{{e}^{{β}_{positive} \cdot X}}{( {e}^{{β}_{positive} \cdot X} + {e}^{{β}_{neutral} \cdot X} + {e}^{{β}_{negative} \cdot X} )} ;$$

$$p 2 = \frac{{e}^{{β}_{neutral} \cdot X}}{( {e}^{{β}_{positive} \cdot X} + {e}^{{β}_{neutral} \cdot X} + {e}^{{β}_{negative} \cdot X} )} ;$$

$$and$$

$$p 3 = \frac{{e}^{{β}_{negative} \cdot X}}{( {e}^{{β}_{positive} \cdot X} + {e}^{{β}_{neutral} \cdot X} + {e}^{{β}_{negative} \cdot X} )} ,$$

At Operation 508, using the three probabilities, the optimization server 312 may determine a gain for displaying the target ad in response to the ad request.

To this end, the optimization server 312 may obtain a reference value for each of the three probabilities from the ad campaign database 322, which includes campaign information of the advertiser that wishes to bid the ad request. The reference values may be values of the corresponding viewer responses from the advertiser's position. For example, a first reference value (V1) may correspond with a positive response (p1), indicating how much value the advertiser believes the ad is worth of when the viewer shows a positive response (e.g., click the ad) towards the target ad; a second reference value (V2) may correspond with a neutral response (p2), indicating how much value the advertiser believes the ad is worth of when the viewer shows a neutral response (e.g., do nothing to the ad) towards the target ad; and a third reference value (V3) may correspond with a negative response (p3), indicating how much value the advertiser believes the ad is worth when the viewer shows a negative response (e.g., close the ad) towards the target ad.

Next, the optimization server 312 may determine an expected gain by the advertiser from the target ad impression with a formula

Gain=p1·V1+p2·V2+p3·V3.

V1, V2, and V3 may be provided by the advertiser or may be provided by an account manager of an account that the advertiser registered with the publisher. Intuitively, an advertiser may place a greatest value on a positive response towards a target ad; an advertiser may place the least value on a negative response towards the target ad; and an advertiser may place little to no value on a neutral response towards the target ad. For example, under a CPC (cost per click) billing method, a neutral response may be valueless to the advertiser because the viewer does not click the target ad; but in a CPI (cost per impression) billing method, the neutral response may have a positive value to the advertiser because after all a neutral response may indicate that an impression is successful delivered to the viewer and the viewer does not dislike it. Accordingly, the reference values for the advertiser may have a relationship as

V1>V2≧0>V3.

Determining the values of V1, V2, and V3 may be application specific and the values may be different case by case based on the advertisers' preferences. For example, in the scenario that the positive response is click, the neutral response is do-nothing, and the negative response is close the ad, the value V1 (e.g., click) may be estimated by post-click conversion-rate times an actual market value of the conversion. For example, suppose the post-click conversion-rate is 5%, and the conversion is defined as an online purchase of a laptop with a profit margin of $200, then the value of V1 may be derived as 5 %×$200=$10. Similarly, the value of V2 may be set by advertisers based on their estimation of the marketing effectiveness. The negative value of V3 brought by an improper impression and closed by the viewer may be learned from offline questionnaires, or from online viewer behavior studies via crowdsourcing internet marketplaces.

Alternatively, the optimization server 312 may determine the negative value of V3 through a controlled field test. For example, the optimization server 312 may randomly split viewers into K equal-sized groups. The optimization server 312 may display to each group a unique variation of an ad (e.g. an animated ad with different movement frequencies). After running for a time period, the optimization server 312 may collect the number of closes and the number of post-impression conversions from different groups. Let close1, . . . , closeK be the number of closes, conversion1, . . . , conversionK be the number of conversions of the K groups, and $ be the profit margin of a conversion, then the negative value of V3 may be estimated by:

$$V 3 = \frac{1}{K ( K - 1 )} {\sum }_{i , j} \$ \times \frac{{conversion}_{i} - {conversion}_{j}}{{close}_{i} - {close}_{j}} .$$

After determining the expected gain for displaying the target ad in respond to the ad request, in Operation 510 the optimization server 312 may determine a recommended bidding price for the bid server 304 based on the expected gain.

To this end, the optimization server 312 may first retrieve the negative feedback aware bidding policies 314. Then the optimization serer 312 may determine the recommended bidding price based on the gain and under the rule of the negative feedback aware bidding policies 314.

The policies 314 may be determined under the condition that a negative response probability of displaying an ad is available. For example, in a campaign with a cost per thousand (CPM) type of billing arrangement, a publisher may charge advertisers a fixed amount (represented by cost per impression, i.e., CPI) of money for each delivered impression. The advertiser may set a goal for cost per click (CPC_{goal}) for the campaign. That is, the advertiser's average cost per click should be no more than its CPC_{goal}. Without considering the probability of negative responses, there may have only two statuses, thereby two probabilities available for determining the bidding price—click and non-click. Accordingly, an optimal bidding policy of the ad campaign may be: bid at the highest price for CPI on those ad requests with highest p(click|ad request, ad) as long as p(click|ad request, ad)≧CPI/CPC_{goal} under the ad campaign budget. With the probability of negative responses, the negative feedback aware bidding policies 314 may require the advertiser to set a goal of gain per impression GPI_{goal}, and the optimal bidding policy may become: bid as high as possible on ad requests whose Gain≧GPI_{goal} under the ad campaign budget. If an ad request does not meet this policy, the optimization server 321 may not recommend bidding the ad request.

In a campaign with a cost-plus type of billing arrangement, a publisher may charge advertisers based on the cost used to purchase the impressions, for example, an impression with a markup. Similar with CPM campaigns, the advertiser may be required to set a CPC_{goal} for the ad campaign. For systems without knowing the probability of negative response, the optimal bidding policy of such campaigns may be: capped by P(clickl|ad request, ad)×CPC_{goal} bid as low as possible as long as budget allows. However, with the probability of negative responses, the negative feedback aware bidding policies 314 may require the advertiser to set a goal of gain per impression GPI_{goal}, and the optimal bidding policy may become: capped by the Gain, bid as low as possible on those ad requests with Gain≦GPI_{goal} as long as the budget allows. If an ad request does not meet this policy, the optimization server 321 may not recommend bidding the ad request.

In a campaign with a cost per click and/or cost per action (CPC/CPA) type of billing arrangement, a publisher may charge advertisers based on the sheer number of clicks/actions realized. The publisher and/or demand-side platform (DSP) may take risks of spending more on obtaining ad inventory but realizes insufficient clicks/actions. Thus in the CPC/CPA fee arrangement, the publisher and/or DSP may set a CPC_{goal} for the campaign to prevent losing profit by delivering too many un-realized impressions. Accordingly, for systems without knowing the probability of negative response, the optimal bidding policy may be: capped by p(click|ad request, ad)×CPC_{goal}, bid as low as possible as long as budget allows. However, with the probability of negative responses, an online advertising service provider, such as the optimization server 312, may more accurately calculate possible of un-realization (possibilities of do-nothing and close), the optimal bidding policy under the negative feedback aware bidding policies 314 may become: capped by the Gain, bid as low as possible as long as the budget allows. If an ad request does not meet this policy, the optimization server 321 may not recommend bidding the ad request.

Accordingly, the optimization server 312 may be able to determine a recommended bidding price under the bidding strategy based on the gain and the negative feedback aware bidding policies.

Additionally, the optimization server 312 may also be able to determine an ad campaign strategy for the advertiser. For example, because the viewer's response may be predicted more accurately, the optimization server 312 may be able to determine a more detailed ad campaign service to the advertiser, such as more confidently offering services to advertiser under CPC/CPA billing arrangement. As another example, under the cost-plus arrangement, the bid price the policy “capped by the Gain, bid as low as possible on those ad requests with Gain≧GPI_{goal} as long as the budget allows” may be implemented in different ways to decide the final bid price. For example, control logic 318 in the optimization server 312 may adjust the bid price to balance the campaign performance and ad delivery as long as the final bid price conform to the corresponding bidding policy.

In Operation 512, the optimization server 312 may store and send the recommended bidding price to a client in obtaining an ad display opportunity associated with the ad request.

The optimization server 312 may store the recommended bidding price to a local or remote transitory and/or non-transitory storage medium. The optimization server 312 may send the recommended bidding price to a client to buy the ad display opportunity associated with the ad request. The client of the optimization server 312 may be the bid server 304 to bid the ad request. The client may also be a publisher or a third party entity. The bid server 304 may use the recommended bidding price as the actual bidding price, or use the recommended bidding price as a reference in determining an actual bidding price. The bid server 304 may send the ad to the browser through the SSP 302 when the actual bidding price wins the ad request.

While example embodiments of the present disclosure relate to systems and methods for online ad campaign optimization, the systems and methods may also be applied to other Applications. For example, the systems and methods may also be applied to other types of auctions; or the systems and methods may be applied to make cost control on commercial activities that have multiple outcomes. The present disclosure intends to cover the broadest scope of systems and methods that implement the technologies described in the present disclosure.

Thus, example embodiments illustrated in FIGS. 1-8 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

1. A computer system, comprising:
a processor-readable, non-transitory storage medium, comprising a set of instructions for optimizing an ad campaign,
a processor in communication with the storage medium, wherein when executing the set of instructions, the processor is directed to:
receive an online ad display request to display an ad to a viewer;
obtain
a first probability that the ad will receive a positive response from the viewer,
a second probability that the ad will receive a neutral response from the viewer, and
a third probability that the ad will receive a negative response from the viewer;
determine a gain value of displaying the ad based on the first probability, the second probability, and the third probability;
determine a bidding price for the ad associated with the ad request based on the gain value; and
send the bidding price to a client in obtaining an ad display opportunity associated with the ad request.

2. The computer system of claim 1, wherein the bidding price is sent to a bid server to buy the ad display opportunity associated with the ad request, and wherein
the positive response comprises clicking the ad,
the neutral response comprises doing nothing to the ad, and
the negative response comprises closing the ad.

3. The computer system of claim 1, wherein to determine the gain value for display the ad, the processor is further directed to:
obtain a first value associated with the positive response towards the ad;
obtain a second value associated with the neutral response towards the ad;
obtain a third value associated with the negative response towards the ad;
determine a first expected gain value of displaying the ad based on the first value and the first probability;
determine a second expected gain value of displaying the ad based on the second value and the second probability;
determine a third expected gain value of displaying the ad based on the third value and the third probability; and
determine the gain value for display of the ad based on the first expected gain value, the second expected gain value, and the third expected gain value.

4. The computer system of claim 1, wherein under an ad campaign with a cost per thousand type of billing arrangement, to determine the bidding price the processor is further directed to,
receive a goal of gain per impression value from an advertiser; and
determine the bidding price as high as possible when the gain value is greater than the goal of gain per impression value.

5. The computer system of claim 1, wherein under an ad campaign with a cost-plus type of billing arrangement, to determine the bidding price the processor is further directed to,
receive a goal of gain per impression value from an advertiser; and
determine the bidding price as low as possible but no lower than the gain value, when the gain value is greater than the goal of gain per impression value.

6. The computer system of claim 1, wherein under an ad campaign with a cost per action or cost per impression type of billing arrangement, the processor is further directed to determine the bidding price as low as possible but not lower than the gain value.

7. The computer system of claim 1, wherein the set of instructions further directs the processor to:
collect data of historical ad display instances, wherein the data of each historical ad display instances comprises:
viewer response information comprising at least one of:
a positive response to the ad display instance from a viewer,
a neutral response to the ad display instance from the viewer, and
a negative response to the ad display instance from the viewer; and
at least one of:
webpage information associated with the historical ad display instance;
ad information associated with the historical ad display instance; and
viewer information associated with the ad display instance.

8. A method for optimizing an ad campaign, comprising:
receiving, by a computer, an online ad display request to display an ad to a viewer;
obtaining, by a computer,
a first probability that the ad will receive a positive response from the viewer,
a second probability that the ad will receive a neutral response from the viewer, and
a third probability that the ad will receive a negative response from the viewer;
determining, by a computer, a gain value of displaying the ad based on the first probability, the second probability, and the third probability;
determining, by a computer, a bidding price for the ad associated with the ad request based on the gain value; and
sending, by a computer, the bidding price to a client in obtaining an ad display opportunity associated with the ad request.

9. The method of claim 8, wherein the bidding price is sent to a bid server to buy the ad display opportunity associated with the ad request, and wherein
the positive response comprises clicking the ad,
the neutral response comprises doing nothing to the ad, and
the negative response comprises closing the ad.

10. The method of claim 8, wherein the determining of the gain value for display the ad comprises:
obtaining a first value associated with the positive response towards the ad;
obtaining a second value associated with the neutral response towards the ad;
obtaining a third value associated with the negative response towards the ad;
determining a first expected gain value of displaying the ad based on the first value and the first probability;
determining a second expected gain value of displaying the ad based on the second value and the second probability;
determining a third expected gain value of displaying the ad based on the third value and the third probability; and
determining the gain value for display the ad based on the first expected gain value, the second expected gain value, and the third expected gain value.

11. The method of claim 8, wherein the determining of the bidding price comprising, under an ad campaign with a cost per thousand type of billing arrangement,
receiving a goal of gain per impression value from an advertiser; and
determining the bidding price as high as possible when the gain value is greater than the goal of gain per impression value.

12. The method of claim 8, wherein the determining of the bidding price comprising, under an ad campaign with a cost-plus type of billing arrangement,
receiving a goal of gain per impression value from an advertiser; and
determining the bidding price as low as possible but no lower than the gain value, when the gain value is greater than the goal of gain per impression value.

13. The method of claim 8, wherein the determining of the bidding price comprising, under an ad campaign with a cost per action or cost per impression type of billing arrangement, determining the bidding price as low as possible but not lower than the gain value.

14. The method of claim 8, further comprising:
collecting, by a computer, data of historical ad display instances, wherein the data of each historical ad display instances comprises:
viewer response information comprising at least one of:
a positive response to the ad display instance from a viewer,
a neutral response to the ad display instance from the viewer, and
a negative response to the ad display instance from the viewer; and
at least one of:
webpage information associated with the historical ad display instance;
ad information associated with the historical ad display instance; and
viewer information associated with the ad display instance.

15. A processor-readable, non-transitory storage medium, comprising a set of instructions for optimizing an ad campaign, wherein the set of instructions, when executed by a processor, directs the processor to perform actions of:
receiving an online ad display request to display an ad to a viewer;
obtaining
a first probability that the ad will receive a positive response from the viewer,
a second probability that the ad will receive a neutral response from the viewer, and
a third probability that the ad will receive a negative response from the viewer;
determining a gain value of displaying the ad based on the first probability, the second probability, and the third probability;
determining a bidding price for the ad associated with the ad request based on the gain value; and
sending the bidding price to a client to obtain an ad display opportunity associated with the ad request.

16. The storage medium of claim 15, wherein the bidding price is sent to a bid server to buy the ad display opportunity associated with the ad request, and wherein
the positive response comprises clicking the ad,
the neutral response comprises doing nothing to the ad, and
the negative response comprises closing the ad.

17. The storage medium of claim 15, wherein the determining of the gain value for display the ad comprises:
obtaining a first value associated with the positive response towards the ad;
obtaining a second value associated with the neutral response towards the ad;
obtaining a third value associated with the negative response towards the ad;
determining a first expected gain value of displaying the ad based on the first value and the first probability;
determining a second expected gain value of displaying the ad based on the second value and the second probability;
determining a third expected gain value of displaying the ad based on the third value and the third probability; and
determining the gain value for display the ad based on the first expected gain value, the second expected gain value, and the third expected gain value.

18. The storage medium of claim 15, wherein the determining of the bidding price comprising, under an ad campaign with a cost per thousand type of billing arrangement,
receiving a goal of gain per impression value from an advertiser; and
determining the bidding price as high as possible when the gain value is greater than the goal of gain per impression value.

19. The storage medium of claim 15, wherein the determining of the bidding price comprising, under an ad campaign with a cost-plus type of billing arrangement,
receiving a goal of gain per impression value from an advertiser; and
determining the bidding price as low as possible but no lower than the gain value, when the gain value is greater than the goal of gain per impression value.

20. The storage medium of claim 15, wherein the determining of the bidding price comprising, under an ad campaign with a cost per action or cost per impression type of billing arrangement, determining the bidding price as low as possible but not lower than the gain value.
